(19) United States
(12) Patent Application Publication
(10) Pub. No.: US 2023/0356469 A1
(43) Pub. Date: Nov. 9, 2023

(54) Method of Generating a Model for Additive Manufacturing

(71) Applicant: United States of America as represented by the Administrator of NASA, Washington, DC (US)

(72) Inventors: John-Andrew Samuel Hocker, Newport News, VA (US); Bordan M. Richter, Norfolk, VA (US)

(21) Appl. No.: 18/143,719

(22) Filed: May 5, 2023

Related U.S. Application Data
(60) Provisional application No. 63/339,149, filed on May 6, 2022.
(60) Provisional application No. 63/398,711, filed on Aug. 17, 2022.

(51) Int. Cl. B29C 64/386

(52) U.S. Cl. CPC B29C 64/386; B33Y 50/00

(57) ABSTRACT

A method of generating a model for additive manufacturing. The method includes obtaining a build file containing instructions to additively manufacture a component and generating at least one point field. The method also includes computing at least one process metric from the at least one point field by selecting at least one principal point from the point field, determining at least one neighborhood using an additive manufacturing model search algorithm for the at least one principal point, and integrating at least one additive manufacturing model kernel function for the at least one principal point and the at least one neighborhood. The method can then update the at least one point field with the at least one process metric computed.

### CROSS-REFERENCE TO RELATED PATENT APPLICATION(S)

This patent application claims the benefit of and priority to U.S. Provisional Patent Application No. 63/339,149, filed on May 6, 2022, and U.S. Provisional Patent Application No. 63/398,711, filed on Aug. 17, 2022, the contents of which are hereby incorporated by reference in their entireties.

### STATEMENT REGARDING FEDERALLY SPONSORED RESEARCH OR DEVELOPMENT

The disclosure described herein was made by employees of the United States Government and may be manufactured and used by or for the Government of the United States of America for governmental purposes without the payment of any royalties thereon or therefore.

### BACKGROUND OF THE DISCLOSURE

Additive manufacturing (AM) is a technology that is shifting both design and manufacturing paradigms. The AM process involves building parts iteratively, step-by-step, and layer-by-layer. The precise sequence allows for the creation of parts with complex geometrical features that would be difficult, and often impossible to fabricate otherwise. AM has been employed in the design of structural parts with maximized strength-to-weight ratios and propulsion components with integrated cooling systems. The ability of AM to produce near-net-shape parts reduces material wastage and manufacturing costs. However, defect formation during the AM process can compromise part performance. The qualification practices for AM parts are an active area and the standards are being developed and modified. The rationale for qualified AM parts will depend on the industry and end application, but it is expected to be based on four governing principles: qualified material process, statistical process control, materials properties suite, and a qualified part process. To enable AM and its advantages to contribute to aerospace and other high-performance applications, it is helpful to develop capabilities for statistical process control by understanding, simulating, and preventing defect formations during the AM process. In particular, part to part build quality must be robust in order to qualify AM parts for any application.

Laser powder bed fusion (L-PBF) is a specific type of AM that uses a powder feedstock that is spread upon a flat substrate and fused by a laser heat source. The fusion process requires both the feedstock and the immediately adjacent substrate to melt. The short duration, translating melt created by the scanning laser is referred to as a melt pool. Melt pool control governs the quality of the weld and, thus, the quality of the part created by the L-PBF AM process.

Defect formation during the build process is usually undesirable and detrimental to the quality of an AM part. A common defect that occurs during L-PBF AM is the formation of porosity induced by keyhole or lack of fusion mechanisms. Porosity is a complex phenomenon that arises from interactions between the feedstock and the process dynamics. The formation strongly depends on the liquation, vaporization, and solidification sequence. Understanding the causalities of porosity is helpful to the qualification of AM parts. Part-scale AM builds must be assessed for the melt track resolved risks of porosity occurrence, both when planning and reviewing a part for aerospace qualification.

The L-PBF AM process is the result of a build strategy applied to parts oriented in the build envelope. A build strategy is comprised of laser powers, foci, and velocities orchestrated in hatch patterns and spacings such that the fusion of feedstock is overlapped to consolidate fully dense additively manufactured parts. When general build strategies are applied to a part, unexpected process conditions can result in underheating or overheating that lead to inconsistent fusion. Hatch pattern, laser power, velocity, and layer thickness are among the primary settings that comprise a build strategy. Each build strategy decision contributes to the overall build quality. AM process design engineers typically develop generalized build strategies that rely on heuristic rules and guidelines to design successful builds. The need for generalized build strategies is due to the broad time and length scales associated with the L-PBF process compared to the melt events.

The complex challenge of qualification and certification of high-quality AM parts can be informed by using computationally efficient multi-scale AM models. Several AM modeling approaches have been developed to predict the temperature field and temperature history of the L-PBF AM process. While valuable for understanding the AM process, high-fidelity melt pool models do not currently significantly inform certification and qualification of parts due to their limited simulation scales and high computational cost. Analytical AM models are computationally efficient approaches that include melt pool models, layer-by-layer thermal models, and velocity-power process maps. Among these, the graph theory-based models and neighboring effect AM modeling method are point field (PF) driven methods. The graph theory-based models calculate a layer-by-layer thermal history using successive time steps. The neighboring effect AM modeling method predicts melt pool areas via neighborhood affected power-velocity and energy density models and requires experimental data to identify optimal coefficients. The variety of these AM modeling approaches reflects the computational challenge associated with the very large-scale differentials between melt pools and part volumes in L-PBF AM.

The scale differentials of the L-PBF AM process can be considered in terms of the melt pool and part volumes. There is a huge differential between the melt pool volume, estimated at 2E-11 m³, and the overall part volume, from 1E-6 m³ to 6.4E-2 m³. The differential translates to 5E-5 to 3.2 trillion melt pools per part, and more if melt pool overlaps are considered. This very large range of scale for L-PBF AM parts remains a significant computational challenge due to modeling and hardware limitations for characterizing and predicting the melt track resolved process conditions. Therefore, there is a need to develop a more computationally efficient approach to assess the AM process at the part scale.

### BRIEF SUMMARY OF THE DISCLOSURE

The disclosure provides multiple analytical additive manufacturing models based on process metrics that can be calculated directly from a point field in a single pass and requires only material property inputs as opposed to finite element thermal modeling approaches that require significant computer power and detailed boundary conditions to generate a process metric, such as a thermal model. The analytical additive manufacturing models are generated based on at least the kernel functions identified above.

In particular, an aspect of the present disclosure includes a method of generating a model for additive manufacturing. The method includes obtaining a build file containing instructions to additively manufacture a component and generating at least one point field. The method also includes computing at least one process metric from the at least one point field by selecting at least one principal point from the point field, determining at least one neighborhood using an additive manufacturing model search algorithm for the at least one principal point, and integrating at least one additive manufacturing model kernel function for the at least one principal point and the at least one neighborhood. The method can then update the at least one point field with the at least one process metric computed.

Also disclosed herein is a non-transitory computer-readable storage medium embodying programmed instructions which, when executed by a processor, are operable for performing the method disclosed above regarding the present disclosure.

These and other features, advantages, and objects of the present disclosure will be further understood and appreciated by those skilled in the art by reference to the following specification, claims, and appended drawings. The present disclosure is susceptible to various modifications and alternative forms, and some representative embodiments have been shown by way of example in the drawings and will be described in detail herein. It should be understood, however, that the novel aspects of this disclosure are not limited to the particular forms illustrated in the appended drawings. Rather, the disclosure is to cover all modifications, equivalents, combinations, sub combinations, permutations, groupings, and alternatives falling within the scope and spirit of the disclosure.

### BRIEF DESCRIPTION OF THE SEVERAL VIEWS OF THE DRAWINGS

FIG. 1 illustrates an example additive manufacturing system.

FIG. 2 illustrates an example point field with a principal point located in a neighborhood.

FIG. 3 illustrates an example method of generating process metrics from at least one point field.

### DETAILED DESCRIPTION OF THE DISCLOSURE

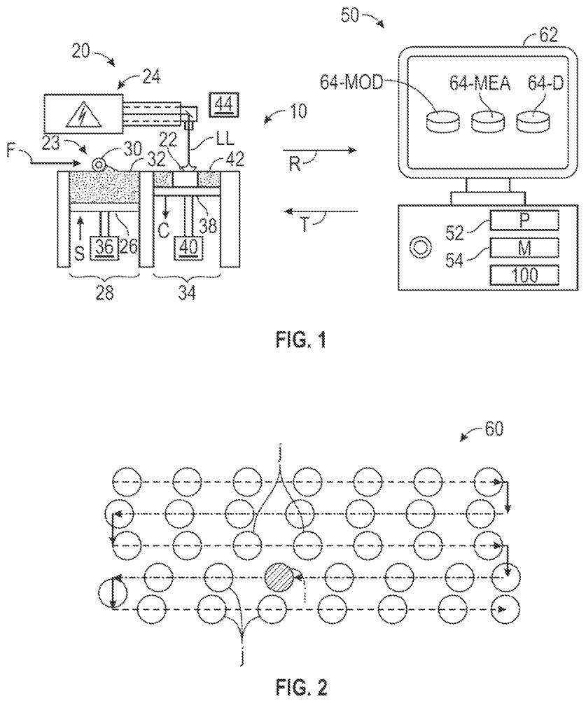

For purposes of description herein, the terms “upper,” “lower,” “right,” “left,” “rear,” “front,” “vertical,” “horizontal,” and derivatives thereof shall relate to orientation shown in FIG. 1. However, it is to be understood that various alternative orientations and step sequences may be envisioned, except where expressly specified to the contrary. Also, for purposes of the present detailed description, words of approximation such as “about,” “almost,” “substantially,” “approximately,” and the like, may be used herein in the sense of “at, near, or nearly at,” or “within 3-5% of,” or “within acceptable manufacturing tolerances,” or any logical combination thereof. It is also to be understood that the specific devices and processes illustrated in the attached drawings, and described in the following specification, are exemplary embodiments of the inventive concepts defined in the appended claims. Hence, specific dimensions and other physical characteristics relating to the embodiments disclosed herein are not to be considered as limiting, unless the claims expressly state otherwise.

Referring to the drawings, wherein like reference numbers refer to like features throughout the several views, FIG. 1 schematically depicts an exemplary additive manufacturing system 20 and a computer system 50 for controlling the additive manufacturing process. The computer system 50 is configured as set forth herein to execute an instruction set T embodying a build file to build a component 22 on the additive manufacturing system 20. The component 22 can be made of aluminum, stainless steel, titanium, metal alloy, or additive manufacturable material in a non-limiting implementation of the present teachings. Furthermore, the computer system 50 can receive information R from in-situ sensors 44 including but not limited to sensors that record the time resolved mirror positions and laser powers for the additive manufacturing system 20 and store the information in a non-transitory computer-readable storage medium (M) 54 in the computer system 50.

The component 22 contemplated herein can in one or more embodiments be constructed via the additive manufacturing process. As will be appreciated by those of ordinary skill in the art, metal-based additive manufacturing or “3D printing” can entail the use of a powder bed fusion process 23 and a concentrated heat source 24, such as but not limited to an electron or laser formation beam LL as shown. Use of the beam LL progressively melts metal powder stock 42 and thereby builds the metal test component 22 in an accumulative or progressive/layer-by-layer manner. The powder bed fusion process 23 shown in FIG. 1 may position a volume of the metal powder stock 32 on a moveable supply platform 26 within a powder feed chamber 28, with a leveling roller 30 possibly translating across the powder feed chamber 28 in the direction of arrow F. This motion enables the leveling roller 30 to displace a thin layer of the metal powder stock 32 toward an adjacent build chamber 34 as the supply platform 26 rises in the direction of arrow S, e.g., using a hydraulic or pneumatic piston 36.

While the illustrated example utilizes the leveling roller 30, other mechanisms, such as a doctor blade, could be used to displace the metal powder stock 32. Furthermore, this disclosure is not limited to additive manufacturing systems 20 L-PBF or PBF-LB/M but applies to additive manufacturing that approaches control position and heat intensity such as when utilizing an e-beam source (power feedback is in electron V/Amps and spot delivery is controlled using magnetic fields) or a fused element deposition additive approach (e.g., heat intensity is controlled through a heated nozzle is controlled through a motorized linear motion “table-top gantry”).

Once the leveling roller 30 has deposited some of the metal powder stock 32 onto a moveable build platform 38 or a previously formed layer of the test component 22, the heat source 24 directs the beam LL onto the deposited metal powder stock 32 according to a predetermined pattern, to thereby construct a layer of the component 22. In one example, the predetermined pattern is determined by a build file stored in the computer-readable storage medium (M) 54 and executed by a micro-processor (P) 52 on the computer system 50. The build platform 38 is then lowered in the direction of arrow C using a piston 40 or another suitable mechanism to enable another layer of the metal test component 22 to be formed. The piston 40 is analogous to the piston 36 but is actuated in the opposite direction. The process repeats until the component 22 has been fully printed, at which point residual powder stock 42 is carefully removed, e.g., via vibration, rinsing, suction, etc.

While the computer system 50 of FIG. 1 is depicted as a unitary computer module for illustrative simplicity, the computer system 50 can be physically embodied as one or more processing nodes having the computer-readable storage medium (M) 54, i.e., application-sufficient memory, and associated hardware and software, such as but not limited to a high-speed clock, timer, input/output circuitry, buffer circuitry, and the like. The computer-readable storage medium 54 may include enough read only memory, for instance magnetic or optical memory. Computer-readable code or instructions embodying a method 100 described below may be executed during operation of the computer system 50. To that end, the computer system 50 may encompass one or more processors (P) 52, e.g., logic circuits, application-specific integrated circuits (ASICs), central processing units, microprocessors, and/or other requisite hardware as needed to provide the programmed functionality described herein. A display screen 62 may be connected to or in communication with the computer-readable storage medium 54 and processor(s) 52 to facilitate intuitive graphical presentation of the results of a method 100 as set forth below.

This disclosure is directed to a method for creating a computationally efficient approach for assessing the additive manufacturing process at a part scale level with fusion level precision (i.e., weld tracks and patters are taken into account) using additive manufacturing models. The method utilizes data from a build file for the part or component 22 stored in the computer-readable storage medium 54 on the computer system 50 or data collected from the in-situ sensors 44 during the additive manufacturing system 20 about the component 22. The build file contains sufficient information, such as build path and heat source intensities, to build the component 22 with the additive manufacturing system 20. The additive manufacturing models can be created from either of these data sets by utilizing a point field driven approach to additive manufacturing modeling to compute process metrics (PM) for the point field describing the component 22. This approach provides a methodology to compute the expected and observed fusion resolved process conditions throughout the additive manufacturing build process. In this disclosure, the method 100 includes a point field driven non-constant kernel convolution calculation.

As will be described in greater detail below, the method 100 comprises point-wise analytical additive manufacturing model defined kernel functions to generate PMs and a model search algorithm to calculate measures of the physical state at each point in a point field 60 (FIG. 2). The PMs provide instantaneous single point-in-time data used for part-scale assessment of the additive manufacturing build integrity or for design improvements to the component 22 through modifying the build file on the computer system 50 for the component 22. The method 100 disclosed herein improves computational speed and precision when compared with other additive manufacturing modeling approaches. The PM approach to additive manufacturing allows for multiple analytical additive manufacturing models to be calculated directly from the point field 60 in a single pass and requires only material property inputs. As a result, calculations of the PMs have a favorable computational speed and operational simplicity for quantifying melt track resolved process conditions from the point field data. For example, the PMs for a point field in this disclosure can be calculated in a number of minutes compared to hours or days for a time-stepped model, such as finite element calculations of thermal rise. These calculations enable efficient prediction, assessment, and adjustment of additive manufacturing builds for reducing defects and developing statistical process controls.

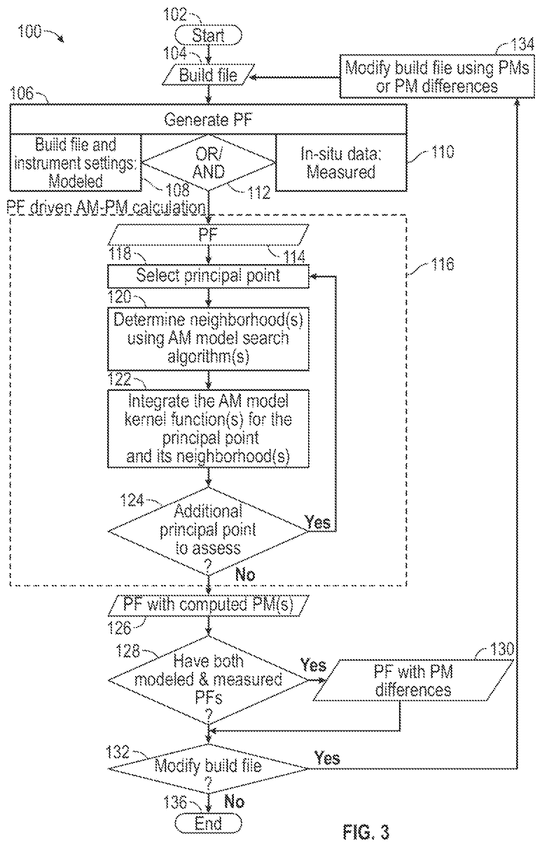

FIG. 3 illustrates the example method 100 of generating at least one point field that include computed PMs for each point in the point field. In one example, the method 100 is implemented on the computer system 50 discussed above. The method 100 initiates a start at Block 102. From the start at Block 102, the method 100 obtains a build file at Block 104 for evaluating the additive manufacturing process for the component 22.

The method 100 then generates at least one point field 60 describing the component 22 as shown in FIG. 2. The point field 60 generated as part of the method 100 (Block 106) is a collection of points having time resolved spatial coordinates and any additional information required to describe an additive manufacturing build, such as the laser spot size and power for L-PBF additive manufacturing. In one example, the point field 60 is generated from the build file for the component 22 to create a model-based point field. (Block 108). In another example, a measured-based point field is generated from the in-situ sensors 44 that record the time resolved mirror positions and laser powers plus any additional information required to describe the additive manufacturing build for the additive manufacturing system 20. (Block 110). In particular, as discussed above, this disclosure applies to other additive manufacturing approaches that may not include mirrors or lasers.

As shown at Block 112, the method 100 can utilize at least one of the model-based point field generated from the build file at Block 108 or the measure-based point field generated from the in-situ measured data for the component 22 at Block 110. Also, the method 100 can utilize a series of builds of the same component 22 to generate multiple corresponding in-situ measured data sets to create a series of measure-based point fields. One feature of analyzing multiple measure-based point fields is to obtain an expected set of value for the points in the point field over series of components 22 built from the same build file. Also, analyzing multiple measure-based point fields for the series of components 22 can indicate if the additive manufacturing system 20 is in need of service or repair by identifying variations in the measure-based point fields and in the computer PMs for the point fields as will be discussed in greater detail below. Another feature of the method 100 is to evaluate the integrity of the build file.

Once the appropriate number of point fields are generated based on at least one of the build file or the in-situ measured data, the method 100 can begin performing PM calculations on the point fields (Block 114) through a process enclosed by Block 116.

Each of the PM calculations is the convolution of a non-constant kernel function, fᵢⱼ, with the neighborhood of the principal point, Øᵢⱼ as shown in Equation (1). A PMᵢ is the calculated PM value at each principal point i, such as the solid circle illustrated in FIG. 2. The chosen kernel function and model search algorithm are defined by the physical model of the additive manufacturing process that is being considered for each principal point in the point field 60.

$$P {M}_{i} = {\sum }_{j}^{N} {f}_{i j} {∅}_{i j} \qquad ( 1 )$$

Each of the point fields from Block 114 are evaluated in terms of a principal point, i, and its neighbors, j, as shown in FIG. 2, with the specific neighbors j being identified by the model search algorithm. The time resolved sequence of the point field points define the laser spot (heat source) movements along the dashed lines, while the laser power levels define whether the movement is a fusion or weld, power on, or a jump, power off. The angles of neighboring meandering hatches of fusions or welds have a difference of π radians, FIG. 2. In Block 118, the method 100 selects a principal point i from the entire point field 60 and then determines at least one neighborhood from and/or including neighbors j from at least one additive manufacturing model search algorithm at Block 120. The model search algorithm will determine the neighbors j that form a neighborhood of points to include in the calculations.

The neighborhood is determined for each principal point i by the model search algorithm, or function set, Øᵢⱼ. In one example, a Heaviside function can be used such that 1 is returned when the spatial and temporal conditions are satisfied and 0 otherwise as shown in Equation (2). The model search algorithm may include spatial conditions such that the distance, rᵢⱼ, is less than or equal to a variable neighborhood distance, Rᵢ.

$${∅}_{i j} = \{ \begin{matrix}1 & if {r}_{ij} \leq {R}_{i} \& {τ}_{ij} \geq {t}_{i}^{delay} \\ 0 & else\end{matrix} \qquad ( 2 )$$

The distance, rᵢⱼ, between the principal i and the neighborhood point j is calculated using the three-dimensional (3D) cartesian coordinate distance as shown in Equation (3). By setting Rᵢ to a constant value C in Equation (4), a non-variable PM neighborhood distance, Rᵢ^{C}, can be taken as a neighborhood radius. Alternatively, Rᵢ in Equation (4) could be functional driven and not always a constant “C.” The coordinate distances on the x, y and z axes are calculated between the principal point i and the neighborhood point j using Equations (5-7).

rᵢⱼ=\sqrt{dxᵢⱼ²+dyᵢⱼ²+dzᵢⱼ²} (3)

Rᵢ^{C}=C, (4)

dxᵢⱼ=xᵢ−xⱼ (5)

dyᵢⱼ=yᵢ−yⱼ (6)

dzᵢⱼ=zᵢ−zⱼ (7)

In one example for calculating PMs in this disclosure, time can be recorded in the point field with a resolution that is equal to or better than the characteristic timescale of the process. In particular, a time scale for a digital galvanometer used in L-PBF additive manufacturing instruments could be 10 μs. The time component of the neighborhood search algorithm is defined as the difference in time, τᵢⱼ, being greater than or equal to a variable time delay, tᵢ^{delay}. Relative to the principal point, I, the neighborhood may be composed of points in the past, τᵢⱼ^{P}, Equation (8); future, τᵢⱼ^{F}, Equation (9); or both, Equation (10).

τᵢⱼ^{P}=tᵢ−tⱼ (8)

τᵢⱼ^{F}=tⱼ−tᵢ (9)

τᵢⱼ^{A}=abs(tᵢ−tⱼ) (10)

Once the neighborhood has been determined based on the model search algorithm, the method 100 can integrate additive manufacturing model kernel functions for the principal point and its neighborhood(s) (Block 122). There are several kernel functions that can be evaluated by the method 100, such as melt pool dimensions, velocity, lack of fusion, or thermal rise, to produce the PMs that are associated with a given principal point i. While these calculations will be discussed in greater detail below, this disclosure is not limited to evaluating only these kernel functions.

For the example of L-PBF additive manufacturing, the patterned movement of the laser across the feedstock creates a melt pool that fuses the powder to the substrate. The melt pool dimensions can be estimated from the material properties and process parameters. As PMs, the melt pool depth, Dᵢ, and width, Wᵢ, can be calculated for each principal point from Equation (11) and Equation (12), respectively. For example, in Equation (11), A is the absorptivity; P is the wattage of the incident heat source; ρ is the bulk material density; cₚ is the bulk material specific heat capacity; Vᵢⱼ is the velocity of the melt pool; Tₘ is the melting temperature of the material; T₀ is the substrate temperature; and e is Euler's number.

$${D}_{i} = \sqrt{\frac{2 {AP}_{i}}{e π ρ {c}_{p} ( {T}_{m} - {T}_{0} ) {V}_{ij}}} \qquad ( 11 )$$

$${W}_{i} = 2 {D}_{i} \qquad ( 12 )$$

For the example of L-PBF additive manufacturing, the process model of the melt pool velocity is taken to be equivalent to the velocity of the laser spot. The neighborhood search algorithm for the melt pool velocity PM is j equal to i−1 and the kernel function is rᵢⱼ over τᵢⱼ^{P} as shown in Equation (13) below.

$${V}_{i j} = \frac{{r}_{i j}}{{τ}_{i j}^{P}} \qquad ( 13 )$$

An additive manufacturing process model can indicate if lack of fusion porosity occurs when the melt pool shape is too small to overlap for a given hatch spacing and layer height. A lack of fusion model can be calculated as one of the PMs, or criterion, for each principal point i once the hatch spacing and layer heights are known at each principal point i. The hatch spacing metric requires a distance measurement to be taken between the principal point i and its nearest neighbor j within the parallel adjacent melt track. To calculate the hatch spacing at each principal point i, a neighborhood model search algorithm must be used such that the neighborhood consists of only the nearest neighbor within the parallel adjacent melt track.

In one example, the neighborhood model search algorithm could be 3π/2>abs(θᵢ^{H}−θⱼ^{H})>π/2 and rᵢⱼ<rᵢₖ, where k is j−1 for dzᵢⱼ≈0. The absolute value of the hatch angle difference being less than 3π/2 and greater than π/2 ensured that the neighbor point was on a separate melt track of the meander hatch pattern. The angle θᵢⱼ relative to the x-axis at each principal point was calculated from arctangent of dyᵢⱼ over dxᵢⱼ as shown in Equation (14). The angle relative to the x-axis is a phase sensitive hatch angle, θᵢ^{H}, when θᵢⱼ is equal to θᵢₖ, where k is i−1 as shown in FIG. 2. The equation of distance for a point from a line was the kernel function between the principal point i and the neighborhood, Equation (15). The resulting point focus driven PM provides the hatch distance at each principal point.

$${θ}_{i j} = {tan}^{- 1} ( \frac{{dy}_{i j}}{{dx}_{i j}} ) \qquad ( 14 )$$

$${f}_{ij}^{H} = \vert cos ( {θ}_{i}^{H} ) {dy}_{ij} - sin ( {θ}_{i}^{H} ) {dx}_{ij} \vert \qquad ( 15 )$$

The inter⁻¹ layer thickness at the principal point, dzᵢⱼ^{H}, was determined using a search algorithm such that dzᵢⱼ, Equation (7), is a minimum value greater than zero. A threshold value of 1 for lᵢⱼ in the lack of fusion criterion additive manufacturing model indicates that lack of fusion porosity will occur. The lᵢⱼ PM can be calculated for each principal point i using Equation (16) once the calculated melt pool dimensions, hatch spacing, and inter-layer thickness are known at each principal point i.

$${l}_{i j} = {( \frac{{f}_{i j}^{H}}{{W}_{i}} )}^{2} + {( \frac{d {z}_{i j}^{H}}{{D}_{i}} )}^{2} \qquad ( 16 )$$

A kernel function for a thermal rise PM is defined as a temperature increase relative to a reference, such as ambient temperature. The PM can be used to determine a point field driven thermal rise at each principal point. In one example, the thermal rise can be calculated from a discrete heat source additive manufacturing process model utilizing a non-constant kernel function where v is the sampling frequency, a is the radius of the heat source, and a is the thermal diffusivity of the material as shown in Equation (17). The thermal rise PM can be interpreted as a transient measure of localized pre-heat temperature when a time delay, tᵢ^{delay}, term is utilized and τᵢⱼ is defined by Equation (8). In one example, a time delay, such as 157 μs, could be chosen such that the neighborhood search algorithm includes only points that are behind the incident heat source by a distance calculated by multiplying 157 μs by Vᵢⱼ. Additionally, when computing one of the melt pool dimensions, a computed value for the thermal rise can be used as the substrate temperature in Equation (11).

$${f}_{i j}^{G} = \frac{A {P}_{j}}{{v}_{j} ρ {c}_{p} \sqrt{2} {{π}^{\frac{2}{3}} ( {σ}_{j}^{2} + 2 α {τ}_{i j} )}^{\frac{2}{3}}} {exp}^{\frac{- {r}_{t j}^{2}}{2 ( {σ}_{j}^{2} + 2 {ατ}_{ij} )}} \qquad ( 17 )$$

If there are additional principal points i to assess from the point field (Block 124), the method 100 can return to Block 118 to evaluate each of the additional principal points i until all of the principal points in the point field have been evaluated. If there are no additional principal points to evaluate, the method 100 continues to Block 126. At Block 126, the method 100 has taken the computed PMs and associated each of them with each of the corresponding points in the point field(s) from Block 114. This will provide PMs for each point in the point field that was subject to calculations through the process enclosed by the Block 116.

If the method 100 computed PMs for the model-based point field and at least one measure-based point field (Block 128), the method 100 can create a comparison of the PMs from the two different point fields. The method 100 can create the comparison by creating a PM differences point field with corresponding points representing the differences in computed PMs between the model-based point field and the measure-based point field at Block 130 or multiple measure-based point fields.

In this disclosure, the model-based point field, the measure-based point field(s), and PM difference point field include corresponding points to allow for comparison of the PMs. In one example, if the PM being compared is velocity, then the method 100 will compare the velocity PM computed for the model-based point field with the velocity PM computed from a corresponding point for the measure-based point field and assign that value to a corresponding point in the PM differences point field. In one example, corresponding points are determined by nearest neighbor in spatial coordinates.

A difference in computed PMs will highlight where the largest variations in PMs occurred between the model and the additively manufactured component. Comparisons of other PMs, such as power, melt pool width Wᵢ, melt pool depth Dᵢ, lack of fusion, or thermal rise, can also be generated between the corresponding points.

As shown in FIG. 1, the computer system 50 can generate a separate graphical representation on the screen 62 of the computer PMs for the model-based point field 64-MOD, the measure-based point field 64-MEA, and the PM differences point field 64-D. In one example, the graphical representations of the model-based point field 64-MOD and the measure-based point field 64-MEA have the same gradient scale and graphical representation of the PM differences point field 64-D has a gradient scale showing the difference from the computed MPs of one of the model-based point field or the measure-based point field. The graphical representation of the PM differences point field 64-D can highlight the differences between the computed PMs for the model-based point field and the measure-based point field that can provide information to aid in improving build quality and identifying potential operational issues with the additive manufacturing system 20 for the component 22.

Once the method 100 has computed PMs associated with at least one of the model-based point field or the measure-based point field, the method 100 can determine if the build file for the component 22 should be modified (Block 132). The method 100 can also use the PM differences point field if one was generated to assist in determining if the build file should be modified. To determine if the build file should be modified, the method 100 can evaluate if any of the PMs or PM differences from the point fields are within a predetermined range for the given PM. If the values are within the range, the method 100 may determine that modifying the build file is not necessary and complete the method at Block 136.

If the values are not within the range, the method 100 may determine that the build file should be modified. If the method 100 determines that the build file should be modified, the method 100 proceeds to Block 134 to modify the build file. The build file can be modified using the computed values for the model-based point field, the computed values for the measure-based point field, or the PM differences point field. These point fields can be used to improve the build file to ensure that the PMs for the modified build file fall within the predetermined range.

Once the modified build file has been generated, the method 100 can return to Block 104 and perform the above-described process based on the modified build file. Also, the computer system 50 could instruct the additive manufacturing system 20 to build a modified component based on the modified build file to provide an iterative evaluation of the component.

Additionally, the parallel and scalable calculation design of the process described within Block 116 and the direct comparison of the computed values for the model-based point field with the measure-based point field discussed above and shown in FIG. 3 are advantages of the point field and PM approach to additive manufacturing modeling and assessment. The computational speed of calculating the PMs enables iterative assessment and tuning of additively manufactured components using the point focused PMs. This allows for several rounds of build files to be evaluated before a single component is ever built and further refinements to be made when PMs are calculated for the measure-based point field for the component to be compared to the calculated PMs for the model-based point field.

While aspects of the present disclosure have been described in detail with reference to the illustrated embodiments, those skilled in the art, now having the benefit of the present disclosure, will recognize that many modifications may be made thereto without departing from the scope of the present disclosure. The present disclosure is not limited to the precise construction and compositions disclosed herein; any and all modifications, changes, and variations apparent from the foregoing descriptions are within the spirit and scope of the disclosure as defined in the appended claims. Moreover, the present concepts expressly include any and all combinations and sub combinations of the preceding elements and features.

What is claimed is:

1. A method of generating a model for additive manufacturing, the method comprising:
obtaining a build file containing instructions to additively manufacture a component;
generating at least one point field;
computing at least one process metric from the at least one point field, wherein computing the at least one process metric includes:
selecting at least one principal point from the point field;
determining at least one neighborhood using an additive manufacturing model search algorithm for the at least one principal point; and
integrating at least one additive manufacturing model kernel function for the at least one principal point and the at least one neighborhood; and
updating the at least one point field with the at least one process metric computed.

2. The method of claim 1, including determining if the build file should be modified based on the at least one process metric.

3. The method of claim 2, including modifying the build file for the component based on the at least one process metric if it is determined that the build file should be modified.

4. The method of claim 1, wherein the at least one additive manufacturing model kernel function is a non-constant kernel convolution calculation.

5. The method of claim 1, wherein integrating at least one additive manufacturing model kernel function for the at least one principal point is based on a single point in time for the at least one principal point.

6. The method of claim 1, wherein generating the at least one point field for the component includes generating a model-based point field from the build file or generating at least one measure-based point field from in-situ measured data.

7. The method of claim 6, wherein the at least one point field for the component includes the model-based point field based and at least one measure-based point field.

8. The method of claim 7, wherein the at least one measure-based point field includes a first measure-based point field from measured data of a first component and a second measure-based point field from measured data of a second component.

9. The method of claim 8, wherein the first component and the second component are constructed from a single build file.

10. The method of claim 7, wherein the in-situ measured data is obtained from in-situ sensors recording time resolved mirror positions and laser powers during a build process for the component from the build file.

11. The method of claim 7, including creating a comparison point field comparing at least one computed process metric from corresponding points from the model-based point field and the at least one measure-based point field.

12. The method of claim 7, wherein the in-situ measured data is obtained from in-situ sensors recording time resolved position and heat source intensity during a build process for the component from the build file.

13. The method of claim 1, wherein the at least one process metric computed includes a melt pool dimension determined from using a value computed for a thermal rise as a substrate temperature.

14. The method of claim 1, wherein the process metrics provide instantaneous point-in-time data regarding the additive manufacturing process for the component.

15. A non-transitory computer-readable storage medium embodying programmed instructions which, when executed by a processor, are operable for performing a method comprising:
obtaining a build file containing instructions to additively manufacture a component;
generating at least one point field for the component;
computing at least one process metric from the at least one point field, wherein computing the at least one process metric includes:
selecting at least one principal point from the point field;
determining at least one neighborhood using an additive manufacturing model search algorithm for the at least one principal point; and
integrating at least one additive manufacturing model kernel function for the at least one principal point and the at least one neighborhood; and
updating the at least one point field with the at least one process metric computed.

16. The non-transitory computer-readable storage medium of claim 15, including determining if the build file should be modified based on the at least one process metric.

17. The non-transitory computer-readable storage medium of claim 16, including modifying the build file for the component based on the at least one process metric if it is determined that the build file should be modified.

18. The non-transitory computer-readable storage medium of claim 15, wherein the at least one additive manufacturing model kernel function is a non-constant kernel convolution calculation.

19. The non-transitory computer-readable storage medium of claim 15, wherein integrating at least one additive manufacturing model kernel function for the at least one principal point is based on a single point in time for the at least one principal point.

20. The non-transitory computer-readable storage medium of claim 15, wherein generating the at least one point field for the component includes generating a model-based point field from the build file or generating at least one measure-based point field from in-situ measured data.
